(19) United States
(12) Patent Application Publication
(10) Pub. No.: US 2026/0045178 A1
(43) Pub. Date: Feb. 12, 2026

(54) SYSTEMS AND METHODS FOR DRIVER TRAINING

(71) Applicant: Ford Global Technologies, LLC, Dearborn, MI (US)

(72) Inventors: Keith Weston, Canton, MI (US); Calvin Trescott, Northville, MI (US); Stuart C. Salter, White Lake, MI (US)

(73) Assignee: Ford Global Technologies, LLC, Dearborn, MI (US)

(21) Appl. No.: 18/797,329

(22) Filed: Aug. 7, 2024

(51) Int. Cl. G09B 19/16; G07C 5/02

(52) U.S. Cl. CPC G09B 19/167; G07C 5/02

(57) ABSTRACT

Systems and method for driver training are provided. Drivers can be trained to drive different types of vehicles using a single vehicle without having to actually get behind the wheel of the different types of vehicle. A first type of vehicle can be equipped with a training/simulation application that can modify certain vehicle parameters to mimic other types of vehicle. For instance, a small box truck can be made to operate like a semi-trailer by adjust certain parameters of the small box truck to cause it to drive like a semi-trailer. A driver can drive the box truck as if he were driving a semi-trailer and the vehicle will monitor the driver performance based on criteria for deriving a semi-trailer. Any driving infractions caused by the driver while he is driving the small box truck in the “semi-trailer” mode may be recorded and used for training and evaluation.

### FIELD

The present disclosure relates to the field of training delivery persons to drive different types of delivery vehicles.

### BACKGROUND

Freight companies and other delivery service providers often have many types of vehicles in their delivery vehicle fleet. These vehicles can range between a small box truck to semi-trailers and tankers. Due to the difference in size and constructions of these various types of delivery vehicles, there is significant difference in the operation of these vehicles. For example, driving a small box truck is very different from driving a semi-trailer. Drivers often need specialized training and certification for driving these different types of vehicles.

Obtaining the specialized training and certification to drive different types of vehicles is often time consuming and expensive. Hence, the availability of drivers that can drive various types of delivery vehicles is limited. This puts severe strain on the operations of delivery service providers. For example, currently there is a shortage of about 80,000 drivers in the US and it is expected to grow to about 160,000 by 2030. It is expected that the industry would need to hire and train over 1 million new drivers to replace the retiring drivers and others who leave voluntarily or involuntarily.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an environment in which embodiments of the present disclosure can be implemented.

FIG. 2 illustrates a block diagram of a vehicle 102 according to an embodiment of the present disclosure.

FIG. 3 illustrates examples of some vehicles that a delivery service provider may have in their fleet of vehicles according to an embodiment of the present disclosure.

FIG. 4 illustrates an example user interface for the driver training system according to an embodiment of the present disclosure.

FIGS. 5A and 5B illustrate an example of modifying the sensor suit of a vehicle of a first type to cause the vehicle to operate as a vehicle of a second type according to an embodiment of the present disclosure.

FIG. 6A illustrates a graph showing the propulsion torque demand during operation of the vehicle according to an embodiment of the present disclosure.

FIG. 6B illustrates graphs showing a scalar modifier that may be applied to the propulsion torque demand request according to an embodiment of the present disclosure.

FIG. 6C illustrates a weighting factor based on the gross train weight of the vehicle according to an embodiment of the present disclosure.

FIG. 7 illustrates a flow chart for a process of operating a vehicle according to an embodiment of the present disclosure.

FIG. 8 illustrates flow chart of a process according to another embodiment of the present disclosure.

FIG. 9 illustrates a block diagram of a process according to yet another embodiment of the present disclosure.

FIG. 10 depicts a block diagram of an example control server according to an embodiment of the present disclosure.

### DETAILED DESCRIPTION

### Overview

The present disclosure describes systems and methods for training drivers to drive various types of delivery vehicles without the need for actually having them to drive the specific type of vehicle that they are learning to drive. For example, a delivery person currently delivering goods in a small box truck can operate the box truck as a semi-trailer thus learning to drive a semi-trailer without the need for a semi-trailer.

Embodiments of the present disclosure provide a method of operating a first type of vehicle as a second type of vehicle. The method includes the vehicle receiving an input indicating selection of a second type of vehicle. The second type of vehicle being different than the first type of vehicle. The method further includes the vehicle determining information about one or more parameters for the second type of vehicle and modifying a configuration of the vehicle based on the one or more parameters for the second type of vehicle. The method further includes operating the vehicle as the second type of vehicle even though the vehicle is of the first type.

In another instance, a vehicle is provided that can reconfigure itself to behave/drive like a different type of vehicle. In order to do that the vehicle determines that the vehicle is of a first type. The vehicle then receives an input indicating selection of a second type of vehicle. The vehicle then determines first values for a first set of parameters associated with the second type of vehicle and determines a second set of parameters of the vehicle that correspond to the first set of parameters. The vehicle then adjusts second values of the second set of parameters to the first values and thereafter operates according to the second set of parameters.

In yet another instance, a method for using a vehicle for driver training is provided. The method includes a first type of vehicle determining that the vehicle is currently being operated by a driver. The method further includes the vehicle receiving an input indicating selection of a second type of vehicle and determining a plurality of parameters associated with the second type of vehicle. The method then includes the vehicle configuring itself using the plurality of parameters and operating as the second type of vehicle based the plurality of parameters. The method further includes the vehicle determining one or more attributes associated with driving the second type of vehicle, monitoring driver behavior based on the one or more attributes, and generating a driving performance report based on the monitoring.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

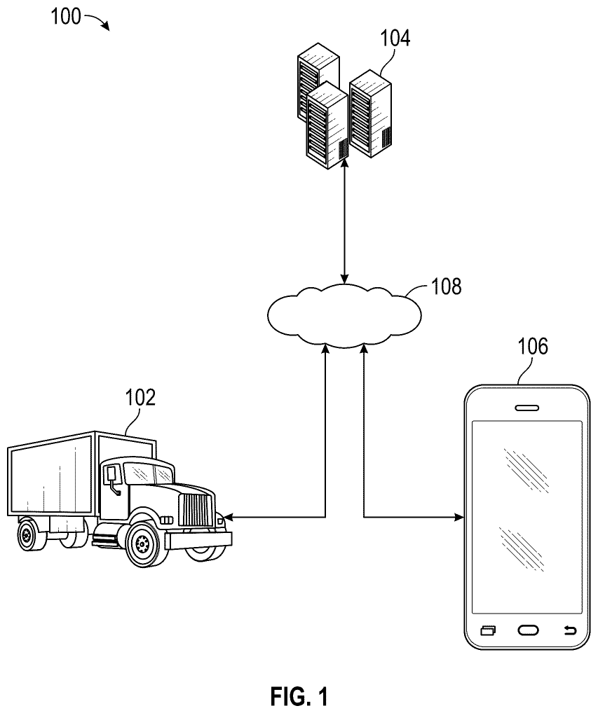

FIG. 1 illustrates an environment 100 in which the embodiments of the present disclosure may be implemented. The environment includes a vehicle 102 that may have the driver training system installed in it. The vehicle 102 can be any passenger or commercial vehicle such as a car, truck, tanker, bus, or the like. The rest of the disclosure will use the example of the vehicle 102 being a commercial delivery vehicle for ease of explanation. The vehicle 102 may be used for a variety of tasks such as carrying packages, goods, heavy machinery, liquids, etc.

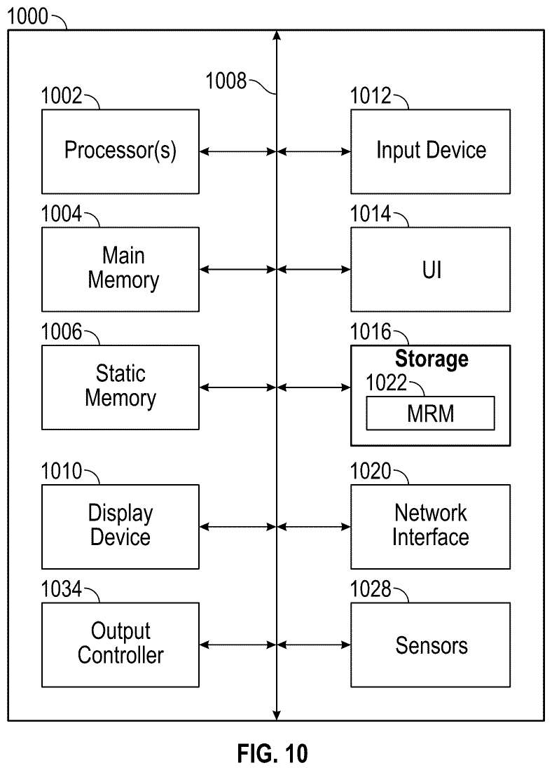

The system 100 may also include a control server 104. The control sever 104 may be part of a cloud-based computing infrastructure and may be associated with and/or include a Telematics Service Delivery Network (SDN) that provides digital data services to the vehicle 102. In additional aspects, the control server 104 may be an assistance server, and may be associated with at least one of a tow assistance firm, a vehicle maintenance and repair firm, an insurance firm, and a transportation firm. Details of the control server 104 are provided below with reference to FIG. 10.

The system 100 may also include a user device 106. The user device 106 may be one of a mobile phone, a tablet, a laptop computer, or the like. The user device 106 may be associated with the driver of the vehicle 102. The user device 106 may receive information from the vehicle 102 and/or the control server 106 regarding the performance of the driver in a particular simulation scenario, as will be explained below. The user device 106 may have a specialized application installed on it that can interface with the vehicle 102 to download and display the driving performance related data.

The system 100 may further include a network 108. The network 108 illustrates an example communication infrastructure in which the connected devices discussed in various embodiments of this disclosure may communicate. The network 108 may be and/or include the Internet, a private network, public network or other configuration that operates using any one or more known communication protocols such as, for example, transmission control protocol/Internet protocol (TCP/IP), Bluetooth®, Bluetooth® low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

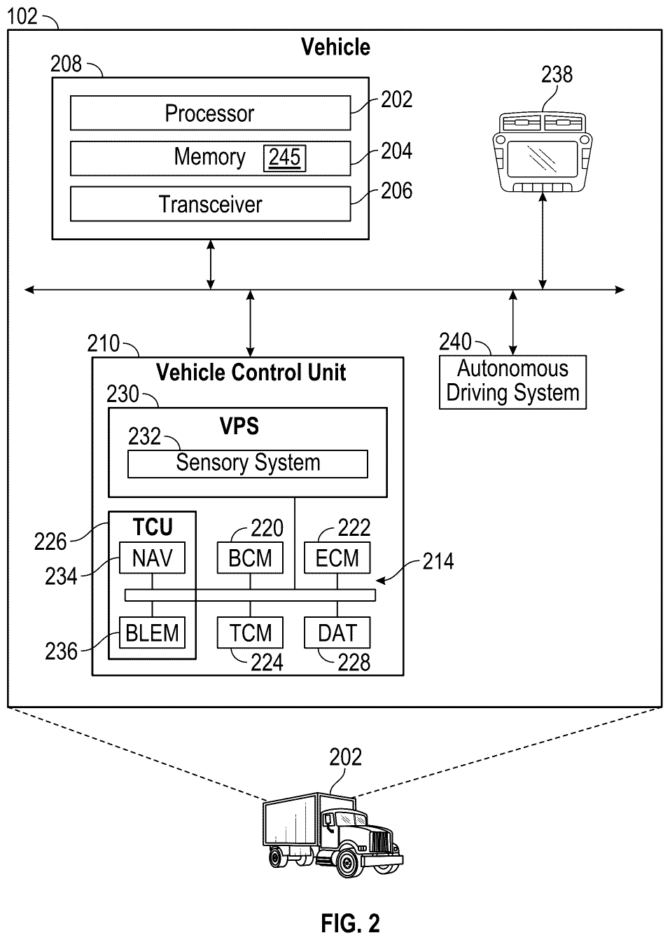

The vehicle 102 may include a plurality of units including, but not limited to, an automotive computer, a Vehicle Control Unit (VCU), and a detection unit. Details of the vehicle 102 are provided below in reference to FIG. 2.

FIG. 2 illustrates a block diagram of the vehicle 102 in which embodiments of the present disclosure can be implemented. The vehicle 102 may include a plurality of units including, but not limited to, an automotive computer 208, a Vehicle Control Unit (VCU) 210, and an infotainment unit 238. The VCU 210 may include a plurality of Electronic Control Units (ECUs) 214 disposed in communication with the automotive computer 208.

In some embodiments, a user device, such as a mobile phone, a laptop computer, or the like may be configured to connect with the automotive computer 208, which may communicate via one or more wireless connection(s), and/or may connect with the vehicle 102 directly by using near field communication (NFC) protocols, Bluetooth® protocols, Wi-Fi, Ultra-Wide Band (UWB), and other possible data connection and sharing techniques.

The automotive computer 208 may be installed anywhere in the vehicle 102, in accordance with the disclosure. The automotive computer 208 may be or include an electronic vehicle controller, having one or more processor(s) 202, one more memories 204, and one or more transceivers 206.

The processor(s) 202 may be disposed in communication with one or more memory devices disposed in communication with the respective computing systems (e.g., the memory 204 and/or one or more external databases not shown in FIG. 2). The processor(s) 202 may utilize the memory 204 to store programs in code and/or to store data for performing operations in accordance with the disclosure. The memory 204 may be a non-transitory computer-readable storage medium or memory storing a vehicle control program code. The memory 204 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 204 may include a module 245 that can implement the various embodiments of the present disclosure. Module 245 may include instructions that can be executed by the processor 202 to realize the various embodiments of the present disclosure.

Automotive computer 208 may also include a transceiver 206. The transceiver 206 may be configured to receive information/inputs from one or more external devices or systems, e.g., a user device 208, an external server, and/or the like. Further, the transceiver 206 may transmit notifications, requests, signals, etc. to the external devices or systems. In addition, the transceiver 206 may be configured to receive information/inputs from vehicle components such as the vehicle sensory system 232, one or more ECUs 214, and/or the like. Further, the transceiver 206 may transmit signals (e.g., command signals) or notifications to the vehicle components such as the BCM 220, the infotainment system 238, and/or the like.

In some embodiments, the VCU 210 may share a power bus with the automotive computer 208 and may be configured and/or programmed to coordinate the data between vehicle systems, connected servers and/or the like. The VCU 210 may include or communicate with any combination of the ECUs 214, such as, for example, a Body Control Module (BCM) 220, an Engine Control Module (ECM) 222, a Transmission Control Module (TCM) 224, a Telematics Control Unit (TCU) 226, a Driver Assistances Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 232 may be coupled to the vehicle 102 at one or more locations and in one or more manner. For example, the various sensors of the vehicle sensory system 232 may be integrated into the various subsystems of the vehicle 102, such as doors, mirrors, roof, etc. or attached to the vehicle 102 using an appropriate mounting mechanism. In some embodiments, the various sensors of the vehicle sensory system 232 may be located at the front, back, sides, top, bottom, and underneath the vehicle 102. The location of a sensor may depend on its function. For example, a sensor that monitors the area underneath the vehicle may be connected to a bottom surface of the vehicle 102 while a sensor that can monitor an area to either side of the vehicle 102 may be mounted or integrated into the doors of the vehicle 102. Vehicle sensory system 232 may also include one or more road noise sensors such as accelerometers that are coupled to various mechanical components and/or systems of the vehicle 102. One skilled in the art will realize that the sensors may be coupled to the vehicles in various different ways and locations other than the ones mentioned above.

In some embodiments, the VCU 210 may control vehicle operational aspects and implement one or more instruction sets received from the server 206, the user device 208, or from one or more instruction sets stored in the memory 204.

The TCU 226 may be configured and/or programmed to provide vehicle connectivity to wireless computing systems onboard and off board the vehicle 102, and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a vehicle key fob (not shown in FIG. 2), an external server, a user device, etc.), computers, and modules. The TCU 226 may be in communication with the ECUs 214 by way of a bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, and/or via wireless signal inputs received via the wireless connection(s) from other connected devices, such as the server 206, among others.

The BCM 220 generally includes integration of sensors, vehicle performance indicators, and variable reactors associated with vehicle systems, and may include processor-based power distribution circuitry that may control functions associated with the vehicle body such as lights, windows, security, camera(s), audio system(s), speakers, wipers, door locks and access control, various comfort controls, etc. The BCM 220 may also operate as a gateway for bus and network interfaces to interact with remote ECUs (not shown in FIG. 2).

The DAT controller 228 may provide Level-1 through Level-3 automated driving and driver assistance functionality that may include, for example, active parking assistance, vehicle backup assistance, and/or adaptive cruise control, among other features. The DAT controller 228 may also provide aspects of user and environmental inputs usable for user authentication.

In some embodiments, the automotive computer 208 may connect with an infotainment system 238 (or a vehicle Human-Machine Interface (HMI)). The infotainment system 238 may include a touchscreen interface portion, and may include voice recognition features, biometric identification capabilities that may identify users based on facial recognition, voice recognition, fingerprint identification, or other biological identification means. In other aspects, the infotainment system 238 may be further configured to receive user instructions via the touchscreen interface portion, and/or output or display notifications, navigation maps, etc. on the touchscreen interface portion.

The computing system architecture of the automotive computer 208 and/or the VCU 210 may omit certain computing modules. It should be readily understood that the computing environment depicted in FIG. 2 is an example of a possible implementation according to the present disclosure, and thus, it should not be considered as limiting or exclusive.

In some embodiments, vehicle 102 may include an autonomous driving system 240. Vehicle 102 may be manually driven or configured to operate, using the autonomous driving system 240, in a fully autonomous (e.g., driverless) mode (e.g., Level-5 autonomy) or in one or more partial autonomous modes which may include driver assist technologies. Examples of partial autonomous (or driver assist) modes are widely understood in the art as autonomy Levels 1 through 4. For example, a vehicle having Level-1 autonomy may include a single automated driver assistance feature, such as steering or acceleration assistance. Adaptive cruise control is one such example of a Level-1 autonomous system that includes aspects of both acceleration and steering.

Level-2 autonomy in vehicles may provide driver assist technologies such as partial automation of steering and acceleration functionality, where the automated system(s) are supervised by a human driver who performs non-automated operations such as braking and other controls. In some embodiments, with Level-2 autonomous features and greater, a primary user may control the vehicle while the user is inside of the vehicle, or in some example embodiments, from a location remote from the vehicle but within a control zone extending up to several meters from the vehicle while it is in remote operation.

Level-3 autonomy in a vehicle can provide conditional automation and control of driving features. For example, Level-3 vehicle autonomy may include “environmental detection” capabilities, where the autonomous vehicle (AV) can make informed decisions independently from a present driver, such as accelerating past a slow-moving vehicle, while the present driver remains ready to retake control of the vehicle if the system is unable to execute the task.

Level-4 AVs can operate independently from a human driver, but may still include human controls for override operation. Level-4 automation may also enable a self-driving mode to intervene responsive to a predefined conditional trigger, such as a road issue or a system event.

Level-5 AVs may include fully autonomous vehicle systems that require no human input for operation and may not include human operational driving controls.

In addition to the components noted above, the vehicle 102 may have numerous mechanical systems and sub-systems. A chassis or frame may form the backbone of the vehicle 102 and support the body and other components of the vehicle 102. The vehicle 102 may include an engine that converts fuel into mechanical power, propelling the vehicle forward. The engine includes various components such as the engine block, pistons, valves, and spark plugs. The vehicle 102 also includes a transmission system. The transmission system transfers the engine's power to the wheels. It includes the clutch, gearbox, driveshaft, and differentials, among other components. The transmission adjusts the power output to suit the vehicle's speed and load. The vehicle 102 may also include a suspension system. The suspension system absorbs shocks and maintains contact between the tires and the road, providing a smooth ride. It includes components such as springs, shock absorbers, and linkages. The vehicle 102 also includes a braking system that allows the driver to slow down or stop the vehicle 102. It includes components like brake pedals, master cylinder, brake lines, and brake pads or shoes. The vehicle 102 also includes a steering system that enables the driver to guide the car. The steering system includes components such as the steering wheel, steering column, rack and pinion, and tie rods. The vehicle 102 also includes an exhaust system that removes and filters the waste gases produced by the engine. It includes the exhaust manifold, catalytic converter, muffler, and tailpipe, among other components. The vehicle 102 also includes a cooling system that prevents the engine from overheating. It includes components such as the radiator, water pump, thermostat, and coolant. The vehicle 102 also includes a cooling system that stores and supplies fuel to the engine. It includes the fuel tank, fuel pump, fuel filter, and fuel injectors. An electrical system of the vehicle 102 powers the car's electrical components. It includes the battery, alternator, starter motor, and wiring. The Heating, Ventilation, and Air Conditioning (HVAC) system regulates the temperature inside the vehicle 102. It includes the heater core, blower motor, and air conditioning compressor. All of the mechanical components working together ensure that the vehicle operates smoothly and satisfactorily.

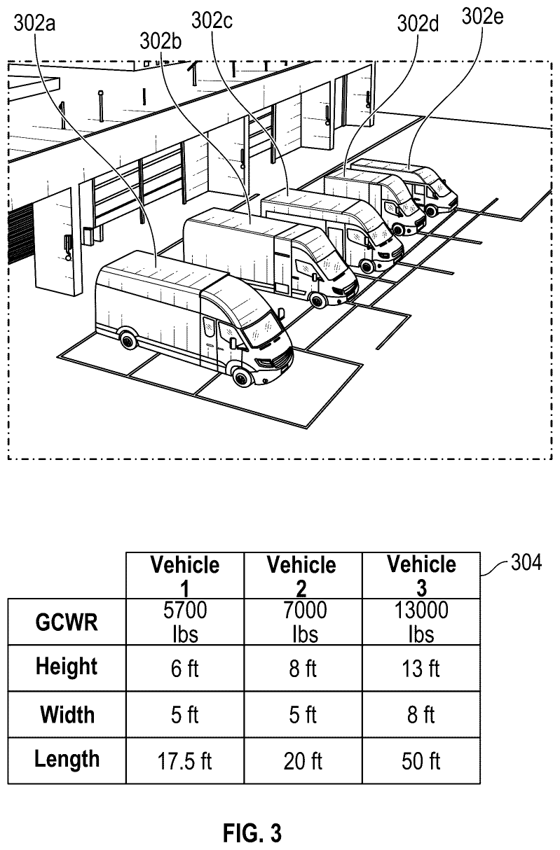

Typically, a delivery service provider or a transportation firm will have various types of vehicles in their fleet. These vehicles can range from a small box truck to a semi-trailer. FIG. 3 illustrates examples of some vehicles that a delivery service provider may have in their fleet of vehicles. As illustrated in FIG. 3, a delivery service provider may have multiple vehicles 302a-302e in their fleet of vehicles. Each of these vehicles may be of a different size, capacity, and configuration and may be used for different purposes. Table 304 illustrates some common features for different types of vehicles. Since the vehicles 302a-302e are of different sizes and configurations, the manner in which they are driven also differs. For example, a small box truck cannot be driven in the same manner as a semi-trailer. While a standard passenger vehicle license may be enough to drive the small box truck, driving a semi-trailer needs specialized training and certification. A delivery service provider will typically employ multiple drivers and each of these drivers may need to be qualified to drive any of the vehicles in the delivery service provider's fleet. Therefore each of the drivers may need to undergo any recommended specialized training for a particular vehicle. Training drivers on multiple types of vehicles is often a time consuming and costly process. Embodiments of the present disclosure solve these issues by allowing a driver who is driving a first type of vehicle, for example a box truck, to practice driving a second type of vehicle, for example a semi-trailer, without the need to change vehicles. In other words, embodiments of the present disclosure can allow a driver to modify parameters of a first type of vehicle to cause the first type of vehicle to drive/operate like a second type of vehicle. In addition, this can all be done in real-time as the driver is delivering goods using the first type of vehicle.

For example, consider that a driver is currently driving a small box truck and delivering packages as part of his/her regular routine. While the driver is on the road travelling from one location to another, the driver can use the embodiments of the present disclosure to cause the small box truck to operate like a semi-trailer. The small box truck will then record the driving behavior of the driver as if the driver was driving a semi-trailer. At the end of the journey, the small box truck can generate a report that details how the driver performed driving a semi-trailer. In this manner, the driver can get experience driving a semi-trailer without actually having to get behind the wheel of a semi-trailer. Also, any driving infractions that the driver may cause during the training will be virtual and not cause any issues on the road.

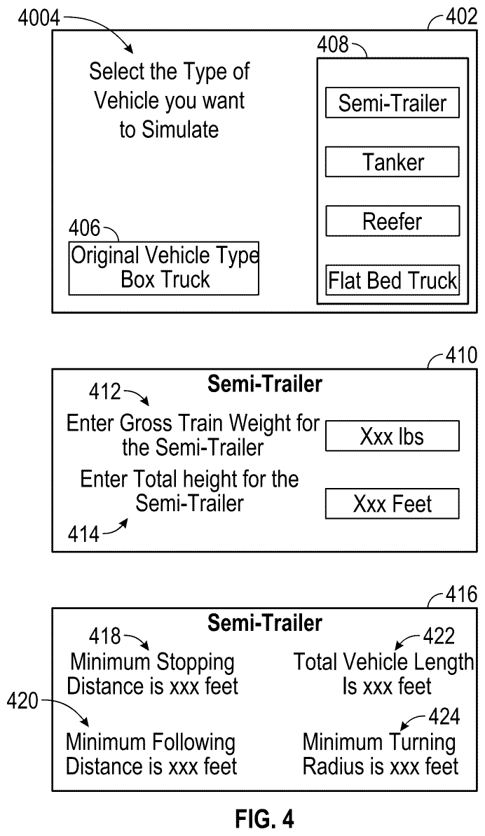

The driver training system can be implemented in various ways. FIG. 4 illustrates an example user interface for the driver training system according to an embodiment of the present disclosure. The user interface can be implemented, e.g., via the infotainment system 238 of the vehicle 102. In other embodiments, the user interface can be implemented using virtual reality (VR) techniques, Heads-up display (HUD), or the like.

When a driver wishes to activate the driver training system, the driver can enable the driver training system, e.g., by selecting a virtual button on the display of the infotainment system or activating a physical button within the vehicle. Once activated, the driver training system may present the screen 402 to the driver. The screen 402 may include information about selecting a vehicle to be simulated (404) and the driver may be given multiple choices 408 to select the desired vehicle type that the driver wants to simulate. The screen 402 may also include information 406 of the original vehicle type of the vehicle 102. In this example, the driver is driving a box truck and is provided with four choices of vehicles that the driver can choose to simulate. Let's consider that the driver chooses “semi-trailer” as the vehicle he/she wants to simulate. Once the driver makes the selection on screen 402, the driver training system may present a screen 410. On screen 410, the driver may be requested to enter certain information associated with the chosen vehicle for simulation. For example, the driver may be asked to enter a gross train weight for the semi-trailer (412) and the overall height of the semi-trailer (414). Driving a fully loaded semi-trailer is different than driving an empty semi-trailer as the gross train weight will affect, e.g., the stopping distance of the semi-trailer. Similarly, the overall height of the semi-trailer will determine a minimum underpass height needed for the semi-trailer to traverse the underpass. The example information shown on screen 410 is exemplary and one skilled in the art will realize that other information in addition to or in lieu of the illustrated information may be requested.

Once the driver has entered the requested information on screen 410, the driver training system may determine various operating parameters associated with the semi-trailer with the chosen features and display some or all of those parameters via a screen 416. These parameters may be information items for the driver to keep in mind as he/she drives the box truck since the box truck will operate as if it was a semi-trailer. For example, the screen 416 may include information such as minimum stopping distance 418, minimum following distance 420, total vehicle length 422, and minimum turning radius 424. All of this information is useful for the driver as he/she drives the box truck.

Once the driver training system is activated and the selections made, the box truck may start monitoring driving performance of the driver as if the driver was driving a semi-trailer. For example, the minimum following distance for the small box truck may be 10 feet but the minimum following distance for the semi-trailer may be 25 feet. So, if the driver does not maintain at least 25 feet of distance between the small box truck and the vehicle in front of it, that driver action may count against the driver even though in reality he/she may be driving per the recommendations for the small box truck. This helps the driver adjust his/her driving behavior to match the recommended operating procedure for a semi-trailer.

As noted above, the embodiments of the present disclosure can be used to modify certain parameters of a vehicle of a first type, e.g., a small box truck, to cause the vehicle to operate like a second type of vehicle, e.g., a semi-trailer. Since the size and configuration of a small box truck is substantially different than a semi-trailer, certain parameters of the small box truck may need to be modified in order to cause the small box truck to drive like a semi-trailer. For instance, the length of a semi-trailer can be as much as twice or three times the length of a small box truck. After the simulation mode is activated, as explained above, the sensor suite of the small box truck may be reconfigured with values consistent with a semi-trailer. For example, the sensors of the small box truck may be configured to cause them to behave as if they were sensors on a semi-trailer. For example, a lane change detection/blind spot monitoring sensor of the small box truck that monitors the proximity of a vehicle behind and/or in the adjacent lane as the small box truck may now operate as if the vehicle was a semi-trailer and not a small box truck.

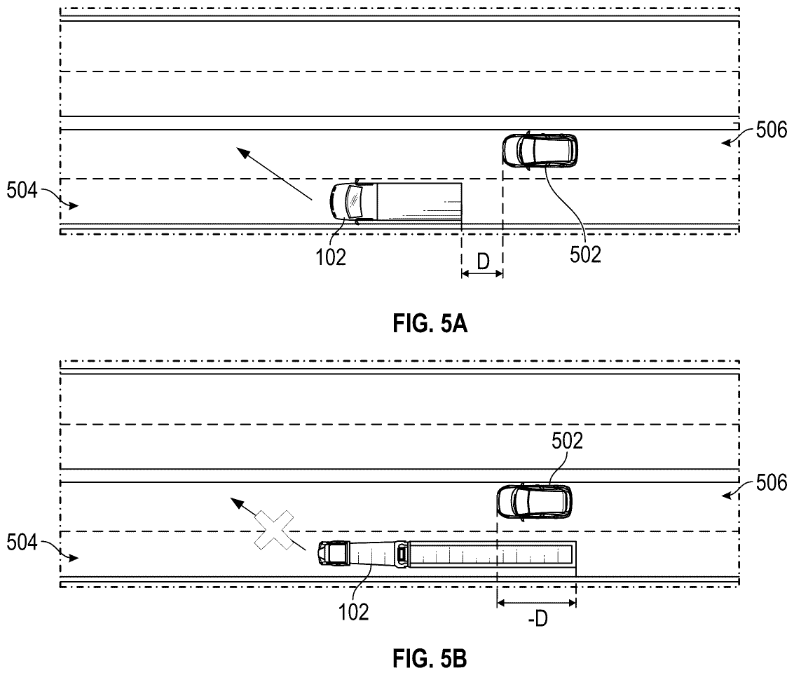

FIGS. 5A and 5B illustrate an example of modifying the sensor suit of a vehicle of a first type to cause the vehicle to operate as a vehicle of a second type according to an embodiment of the present disclosure. As illustrated in FIG. 5A, the vehicle 102 (e.g., a small box truck) is travelling on a road in a first lane 504 and another vehicle 502 (e.g., car) is travelling in an adjacent lane 506. In a default operation mode, the vehicle 102 is operating like a small box truck. If the driver of the small box truck wishes to change lanes, the sensor suite of the vehicle 102 may determine that the distance ‘D’ between the vehicle 102 and the other vehicle 502 is enough for the driver to change lanes proficiently. Thus, in this instance, the driver may change lanes without any alerts from the sensor suite. However, after the simulation/training mode is activated, the vehicle 102 now operates like a semi-trailer, as illustrated in FIG. 5B. The sensor suite of the vehicle 102 is reconfigured to operate as if the vehicle 102 is now much longer in length than its actual length. Therefore, if the driver of vehicle 102 attempts to change lanes in the scenario illustrated in FIG. 5B, the sensor suite of the vehicle 102 may output alerts indicating that it is not optimal to change lanes as the distance between the front of the vehicle 502 and the back of the vehicle 102 is now less than (distance-D) the recommended lane change distance for a semi-trailer. It is to be noted that even in the scenario of FIG. 5B the physical vehicle 102 is still a small box truck, however, the vehicle 102 is virtually behaving like it is a semi-trailer. So, if the driver of the vehicle in the scenario of FIG. 5B changes lanes ignoring the alerts from the sensor suite, the vehicle may log this maneuver as being non-recommended and add that information to the driving log/record, but there will be no issues on the road since the actual vehicle 102 is still a box truck and the real-world scenario is still as illustrated in FIG. 5A, which is within the recommended parameters of a small box truck.

Similar to reconfiguring the sensor suite, other parameters of the vehicle 102 may also be reconfigured to cause the vehicle 102 to behave like the vehicle selected for training/simulation. In an embodiment, the braking behavior may be reconfigured. Delivery vehicles are equipped with various types of braking systems. For instance a vehicle may be equipped with air brakes, hydraulic brakes, transmission brakes, disc brake, drum brakes, electric brakes, pneumatic brakes, or electromagnetic brakes. Each of these brake systems operates differently and the methods for using these brake systems are often not transferable. Thus, a driver driving a particular vehicle needs to have the knowledge of type of braking system for the vehicle and the proper method of operating the braking system. Continuing with our example from above, consider that the vehicle 102 is equipped with a disc brake system. Therefore, prior to activation of the training/simulation mode, the driver of the vehicle 102 may operate the vehicle 102 based on the recommended operating method for disc brakes. Upon activation of the simulation/training mode, the vehicle 102 may reconfigure the braking system to now operate as if the vehicle 102 has air brakes. Therefore, when in the training mode, the driver of the vehicle 102 is evaluated based on how well he/she is operating an air brake system. It is to be noted that since a disc brake system and an air brake system are different in physical construction, not all aspects of an air brake system may be activated in the simulation/training mode.

For example, simulating an air brake system using a disc brake system may involve creating a dynamic mathematical model of the air brake system and the disc brake system. The air brake system may be decomposed into its basic standard pneumatic components such as cylinder, nozzle, air reservoir, volume, and air pipe and its other components such as the brake valve, relay valve, and brake chamber. Similarly, the disc brake system may be decomposed into its basic components such as actuating valves, control valves, actuators, and foundation brakes. The two models may then be combined to simulate an air-disc brake system. The simulation may include adjusting response time of the existing disc brake system of the small box truck to mimic the air brake system of a typical heavy commercial vehicle such as the semi-trailer.

Similarly, other aspects of the semi-trailer may also be simulated. For instance, upon activation of the simulation/training mode, the turning radius, steering wheel angles, stopping distance, following distance, etc. of the small box truck may be modified to values that are typical of the semi-trailer being simulated. For example, some organizations recommend that if you are driving below 40 mph, you should leave at least one second for every 10 feet of vehicle length. For a typical semi-trailer, this results in 4-8 seconds between the semi-trailer and the leading vehicle. For speeds over 40 mph, one additional second should be added to the 4-8 seconds. For a small box truck that is approximately 20 feet in length travelling at 40 mph, this translates to approximately 2 seconds (or about 120 feet) of following distance. For a semi-trailer that is 50+ feet in length, the following distance may be approximately 8 seconds (or about 500 feet). So, in the simulation/training mode, the vehicle 102 may use the value of 500 feet as the following distance between the vehicle 102 and any other vehicle in front of it. The driver's driving performance may be evaluated based on comparing the current following distance with the threshold distance of 500 feet. Hence, as the driver is operating the vehicle 102 on the road, whenever the following distance falls below 500 feet, the vehicle may output an alert message to the driver that he/she is close to the vehicle in front and use that information in driving performance evaluation of the driver. It is to be noted that the braking and following distance are merely examples of vehicle attributes that can be modified for the simulation/training. One skilled in the art will understand that other aspects or characteristics of the vehicle 102 may also be modified to cause the vehicle 102 (small box truck) to operate like a different vehicle (semi-trailer).

The performance of a vehicle changes based on the driving conditions. For instance, a driver may need to alter his/her driving behavior when operating a vehicle in rainy conditions compared to operating that same vehicle on a sunny day. Similarly, driving on a paved surface is not the same as driving on a mud or gravel road. Based on the road and environmental conditions, the driver may need to alter the driving behavior to proficiently operate the vehicle. Embodiments of the present disclosure also allow modification of vehicle characteristics under different driving conditions to train the driver. For example, the driver may simulate driving on a mud road when in reality he/she may be driving on a paved surface. In this example, some of the vehicle characteristics may be altered to cause the vehicle to behave as if the vehicle is operating on a mud road, even though in reality the vehicle is operating on a paved surface. In an embodiment the driver demand curve associated with a vehicle may be modified in order to cause the vehicle to operate in a certain environment or road conditions.

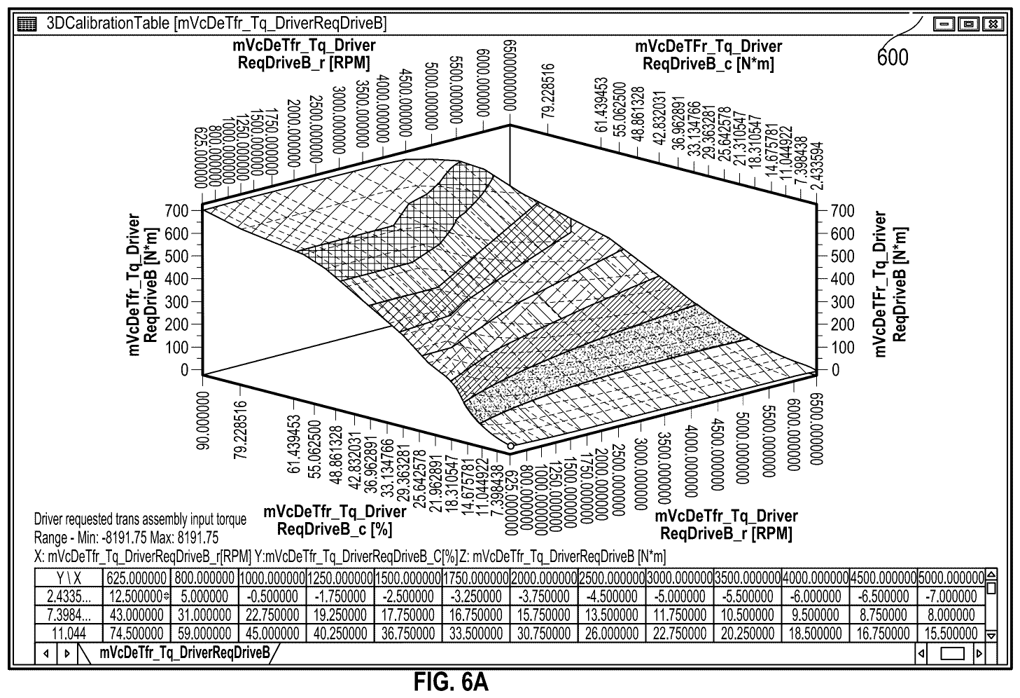

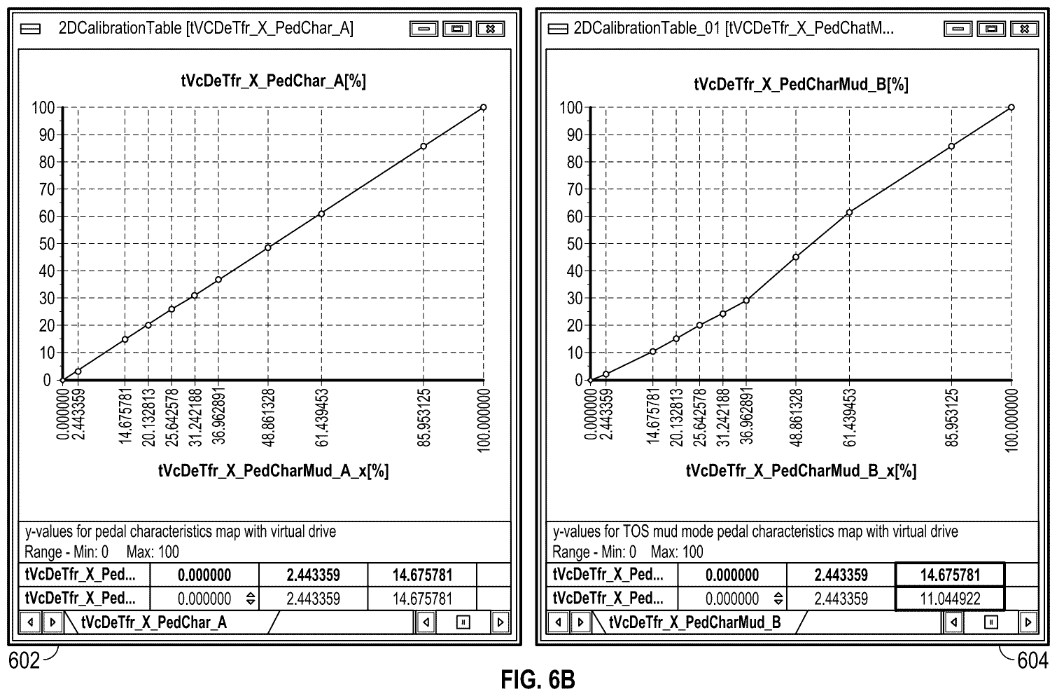

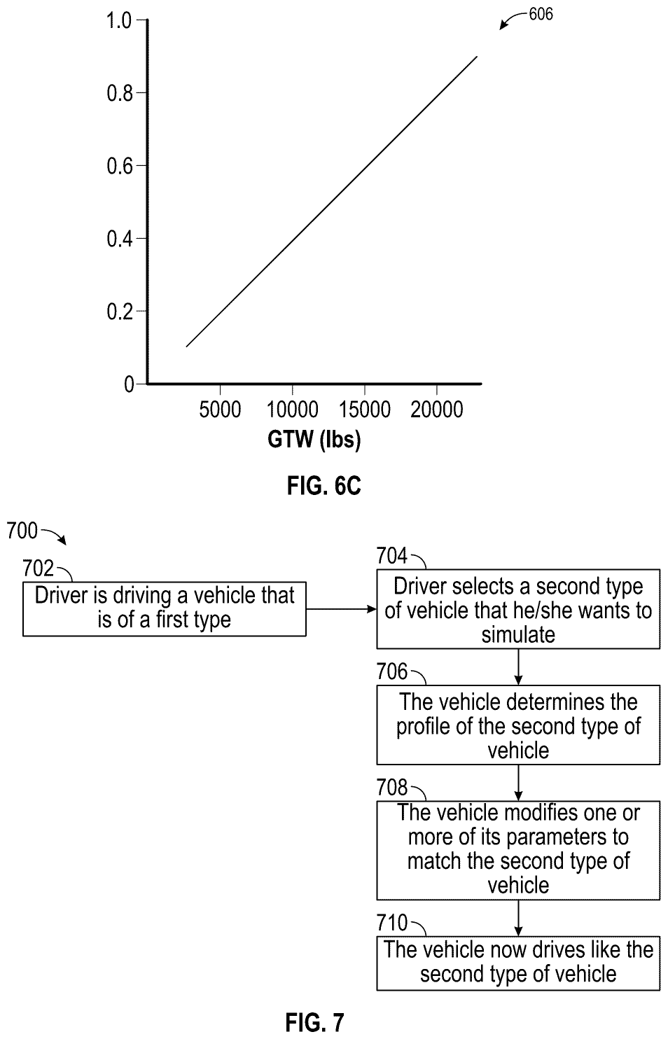

FIG. 6A illustrates a graph 600 showing the propulsion torque demand during operation of the vehicle according to an embodiment of the present disclosure. Graph 600 illustrates a driver demand map for a particular vehicle. The x-axis represents the engine speed in revolutions per minute (rpm), the y-axis represents accelerator pedal position in percentage, and the z-axis represents the driver requested torque in N*m. The driver demand curve may be unique for each vehicle or each vehicle type and is programmed into the vehicle at the time of manufacture of the vehicle. When the vehicle is driven under differing road and/or environmental conditions, a scalar modifier may be applied to the accelerator pedal position to account for the specific road/environmental conditions. FIG. 6B illustrates a scalar modifier that may be applied to the torque demand request illustrated in graph 600 according to an embodiment of the present disclosure. Graph 602 illustrates a scalar modifier associated with a first operating condition that may be applied to the accelerator pedal position in the driver demand map 600 prior to the vehicle using the values for torque determination. Graph 604 illustrates another scalar modifier associated with a different operating condition, e.g., mud road, that may be applied to the accelerator pedal position in the driver demand map prior to the vehicle using the values for torque determination. These scalar modifiers may be applied to the driver demand curve 600 to modify the vehicle behavior. In some embodiments, a scalar modifier based on the type of the vehicle may be used to alter the driver demand map. For example, a small box truck may have a range of first scalar modifier values for the accelerator pedal positions between 0% and 100% and a semi-trailer may have a range of second scalar modifier values for the accelerator pedal positions between 0% and 100%. In addition, a weighting factor of between 0 and 1 may be determined based on the gross train weight (GTW) of the vehicle.

FIG. 6C depicts a graph 606 that illustrates the relationship between a weighting factor and the GTW of a vehicle according to an embodiment of the present disclosure. For example, for vehicles with GTW of about 5000 lbs, a factor of 0.2 may be used and for vehicles with GTW of about 20,000 lbs, a factor of 0.8 may be used. In one embodiment, the scalar modifier value for the accelerator pedal position, e.g., the values illustrated in graphs 602 and/or 604, may be further multiplied by the weighting factor based on the GTW of the vehicle, e.g., as illustrated in graph 606, to obtain a modified scalar value for the accelerator pedal position. This modified scalar value is then applied to the driver demand curve, e.g., graph 600, of the vehicle to generate a modified driver demand curve. The modified driver demand curve is then used to control the operation of the vehicle. In an embodiment, the power control module (PCM) of the vehicle may receive the GTW information, as illustrated in FIG. 4 above, and then use the appropriate weight factor to apply to the scalar modifier for the accelerator pedal position to generate the modified scalar modifier. It is to be understood that graph 606 is exemplary and other values for the weighting factor may be used for different GTW values.

While in the simulation/training mode, the driver still has override authority over the applied settings. For example, in instances where the simulation/training mode results in modifying the throttle response performance of the vehicle, the driver may override the modified throttle response parameters, e.g., by pressing the accelerator pedal past a detent, using voice command, selecting an option on the infotainment/Human Machine interface (HMI) system, or activating a dedicated button. Similarly, the driver may also have override authority over the brake system settings and driver may override the brake system settings using similar means as stated above. Other vehicle parameters that may be modified for purposes of training/simulation may include modifications to the power output of the vehicle, off road capability of the vehicle, tractive capability, power train capacity, etc.

FIG. 7 illustrates a flow chart for a process 700 of operating a vehicle according to an embodiment of the present disclosure. Process 700 may be performed, for example, by vehicle 102 of FIG. 2. At step 702, the vehicle may determine that it is being currently operated (e.g., driven on a road). The vehicle also knows/determines that is if of a first type and has a first configuration. For example, the vehicle may be a box truck. At step 704, the vehicle receives information indicating a selection to operate as a second type of vehicle. This may done, for example, by the driver selecting an option via the HMI of the vehicle as illustrated in FIG. 4. The second type of vehicle is different than the first type of vehicle. Once the selection information is received, the vehicle determines the profile of the second type of vehicle at step 706. For example, if the second type of vehicle is a semi-trailer, the vehicle may determine a size (height, length, and width), weight, stopping distance, etc. associated with a semi-trailer. This profile information will be different than the default profile information for the vehicle. Based on the profile information determined for the second type of vehicle, the vehicle may modify one or more parameters of one or more systems/components. For example, the vehicle may modify the minimum following distance requirement, minimum stopping distance requirement, maximum allowable speed, etc. to values corresponding to the profile of the second type of vehicle. Thereafter the vehicle then operates based on the parameters of the second type of vehicle at step 710. In other words, the vehicle now operates like a semi-trailer and not like a box truck.

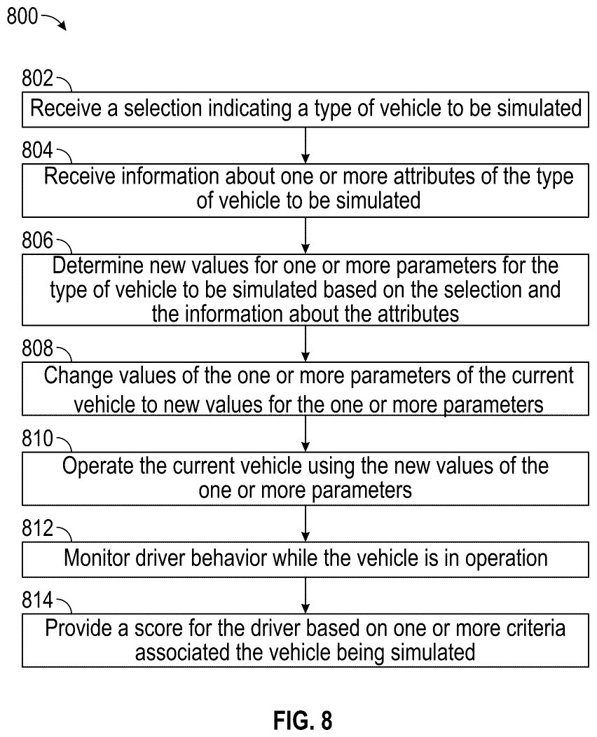

FIG. 8 illustrates flow chart of a process 800 according to an embodiment of the present disclosure. Process 800 may be performed, e.g., by the vehicle 102 of FIG. 2. At step 802, the vehicle may receive a selection indicating that a driver of the vehicle would like to simulate a different type of vehicle than the current vehicle. For example, the current vehicle may be a small box truck and the driver may want to simulate a semi-trailer, which is a different type of vehicle than the box truck. At step 804, the vehicle may optionally receive additional information about the type of the vehicle to be simulated, e.g., as described in reference to FIG. 4 above. Based on the information received in steps 802 and 804, the vehicle may determine new values for one or more parameters associated with the vehicle to be simulated, at step 806. The one or more parameters may include size, minimum following distance requirement, minimum stopping distance requirement, maximum allowable speed, etc. In an embodiment, the vehicle may reconfigure its sensors based on the new values for the one or more parameters. At step 808, the vehicle may modify its current parameters that correspond to the one or more parameters for the vehicle to be simulated using the new values determined in step 806. Thereafter, the vehicle operates using the new values of the parameters associated with the vehicle to be simulated at step 810. For example, the small box truck now operates as a semi-trailer. As the driver operates the vehicle, the vehicle may monitor the driver performance based on the new values for the one or more parameters at step 812. For example, if the following distance recommendation for the small box truck is 120 feet and the following distance recommendation for the semi-trailer is 500 feet, the vehicle will now evaluate driver performance based on the semi-trailer recommendation even though the driver is actually driving a small box truck. At step 814, the vehicle may generate a driving performance evaluation report that may include a driving score. The driving performance evaluation report may include other details regarding the driver performance criteria such as basic vehicle control, traffic interaction, adherence to traffic laws, defensive driving skills, parking and maneuvering, and judgement and decision making. The driving performance evaluation report may also include a summary of overall performance, strengths, weaknesses, and recommendations for improvement, if applicable and suggestions for additional training or practice.

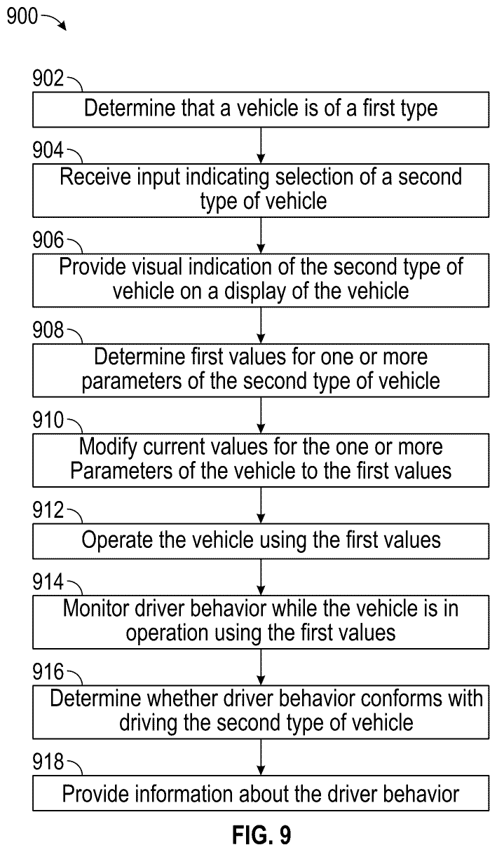

FIG. 9 illustrates a block diagram of a process 900 according to an embodiment of the present disclosure. Process 900 may be performed, e.g., by the vehicle 102 of FIG. 2. At step 902, the vehicle may determine that it is a first type of vehicle. For example, this could be the default vehicle configuration and the vehicle may be a small box truck. At step 904, the vehicle may receive an input indicating that the driver of the vehicle wishes to cause the vehicle to operate like a second type of vehicle. This selection may be made using the HMI system of the vehicle as described with respect to FIG. 4 above. For example, the vehicle may receive an input that indicates that the driver wishes for the small box truck to operate like a semi-trailer. The input may activate the simulation/training mode of the vehicle. At step 906, the vehicle may provide a visual indication, e.g., on the HMI interface or via a VR display, to the driver showing the second type of vehicle. For example, the small box truck may now display a semi-trailer on the HMI interface so that the driver of the vehicle is notified that the semi-trailer simulation/training is now in effect. From here on the driver will have to drive the small box truck as if it were a semi-trailer.

At step 908, the vehicle determines values for one or more parameters associated with the second type of vehicle. The parameters may be related to the braking system, the propulsion system, the size, and/or operating conditions of the second type of vehicle. Once these values are determined, the vehicle may modify the current values of these parameters for the vehicle to now use the values determined for the second type of vehicle (step 910). In other words, the vehicle is configured to behave and drive like a semi-trailer and not like a small box truck. Thereafter, at step 912 the vehicle now operates using the new values for the one or more parameters. Examples of these one or more parameters are explained above and are not repeated here for brevity. From here on the vehicle now operates as if it were a semi-trailer. As the driver is driving the vehicle on the road, the vehicle monitors the driver's performance based on criteria for a semi-trailer and not the small box truck (step 914). For example, consider that the driver is making a right turn at an intersection. The manner in which the turn should be executed will differ based on the type of vehicle considering the clearance distance from the curb, other objects in the environment, etc. If the driver executes the turn as recommended for a small box truck, it is likely that the turn maneuver will be problematic if he/she were driving a semi-trailer and the vehicle may contact one or more objects in the environment during the turn. In this scenario, the vehicle sensors will register this “virtual” contact with objects in the environment and store this information in the vehicle memory since the vehicle is now behaving as if it were a semi-trailer. However, in the real-world, there would be no issue since the driver has correctly executed the turn for a small box truck. This helps to train the driver without causing issues in the real-world.

At step 916, the vehicle monitors the driver behavior and determined whether it complies with the criteria for driving the second type of vehicle. After completion of the trip and/or ending the simulation/training mode, the vehicle may generate a driving performance report at step 918. The driving performance report may include information about how the driver fared in his/her driving of the second type of vehicle. The information in the driving performance report may be used by the driver to understand areas of improvement and enhance their driving technique.

FIG. 10 depicts a block diagram of an example control server 1000, e.g., control server 104 of FIG. 1, upon which any of one or more techniques (e.g., methods) may be performed, in accordance with one or more example embodiments of the present disclosure. In other embodiments, the server 1000 may operate as a standalone device or may be connected (e.g., networked) to other servers. In a networked deployment, the server 1000 may operate in the capacity of a server machine, a client machine, or both in server-client network environments. In an example, the server 1000 may act as a peer server in peer-to-peer (P2P) (or other distributed) network environments. The server 1000 may be a personal computer (PC), a tablet PC, a set-top box (STB), a personal digital assistant (PDA), a mobile telephone, a smart key fob, a wearable computer device, a web appliance, a network router, a switch or bridge, or any machine capable of executing instructions (sequential or otherwise) that specify actions to be taken by that server, such as a base station. Further, while only a single server is illustrated, the term “server” shall also be taken to include any collection of servers that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific task when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The server (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The server 1000 may further include a graphics display device 1010, an alphanumeric input device 1012 (e.g., a keyboard), and a user interface (UI) navigation device 1014 (e.g., a mouse). In an example, the graphics display device 1010, alphanumeric input device 1012, and UI navigation device 1014 may be a touch screen display. The server 1000 may additionally include a storage device (i.e., drive unit) 1016, a network interface device/transceiver 1020 coupled to antenna(s), and one or more sensors 1028, such as a global positioning system (GPS) sensor, a compass, an accelerometer, or other sensor. The server 1000 may include an output controller 1034, such as a serial (e.g., universal serial bus (USB)), parallel, or other wired or wireless (e.g., infrared (IR)), near field communication (NFC), etc. connection to communicate with or control one or more peripheral devices (e.g., a printer, a card reader, etc.).

The storage device 1016 may include a machine readable medium 1022 on which is stored one or more sets of data structures or instructions (e.g., software) embodying or utilized by any one or more of the techniques or functions described herein. The instructions may also reside, completely or at least partially, within the main memory 1004, within the static memory 1006, or within the hardware processor 1002 during execution thereof by the server 1000. In an example, one or any combination of the hardware processor 1002, the main memory 1004, the static memory 1006, or the storage device 1016 may constitute machine-readable media.

While the machine-readable medium 1022 is illustrated as a single medium, the term “machine-readable medium” may include a single medium or multiple media (e.g., a centralized or distributed database, and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the server 1000 and that cause the server 1000 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver 1020 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1020 may include one or more physical jacks (e.g., Ethernet, coaxial, or phone jacks) or one or more antennas to connect to the communications network. In an example, the network interface device/transceiver 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the server 1000 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

It is to be noted that the vehicle implements and/or performs operations, as described here in the present disclosure, in accordance with the owner manual and safety guidelines. In addition, any action taken by the vehicle owner based on recommendations or notifications provided by the vehicle should comply with all the rules specific to the location and operation of the vehicle (e.g., Federal, state, country, city, etc.). The recommendation or notifications, as provided by the vehicle, should be treated as suggestions and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving, by a vehicle of a first type, an input indicating selection of a second type of vehicle, wherein the second type of vehicle is different than the first type of vehicle;
determining, by the vehicle, information about one or more parameters for the second type of vehicle;
modifying, by the vehicle, a configuration of the vehicle based on the one or more parameters for the second type of vehicle; and
operating, by the vehicle, as the second type of vehicle.

2. The method of claim 1, wherein the first type of vehicle is a small box truck and the second type of vehicle is a semi-trailer.

3. The method of claim 1, wherein the receiving the input comprises receiving the input via a human machine interface of the vehicle.

4. The method of claim 1, wherein the one or more parameters include, length, width, height, or gross train weight.

5. The method of claim 1, wherein modifying the configuration further comprises:
determining one or more criteria associated with the second type of vehicle; and
modifying a profile of the vehicle to use the one or more criteria.

6. The method of claim 5, further comprising monitoring a driving performance of a driver operating the vehicle, based on the one or more criteria, wherein the one or more criteria include following distance, stopping distance, or turning radius.

7. The method of claim 6, further comprising generating a driving performance evaluation report including a driving score for the driver.

8. A vehicle comprising:
one or more processors;
one or more memories storing instructions and coupled to the one or more processors; and
one or more sensors coupled to the one or more processors, wherein the one or more processors are configured to execute the one or more instructions that cause the vehicle to:
determine that the vehicle is of a first type;
receive an input indicating selection of a second type of vehicle;
determine first values for a first set of parameters associated with the second type of vehicle;
determine a second set of parameters of the vehicle that correspond to the first set of parameters;
adjust second values of the second set of parameters to the first values;
operate according to the second set of parameters.

9. The vehicle of claim 8, wherein the one or more processors are configured to execute the one or more instructions that further cause the vehicle to configure the one or more sensors based on one or more attributes of the second type of vehicle.

10. The vehicle of claim 9, wherein the one or more attributes include length, width, height, and gross train weight.

11. The vehicle of claim 8, wherein the one or more processors are configured to execute the one or more instructions that further cause the vehicle to monitor performance of a driver of the vehicle.

12. The vehicle of claim 11, wherein the one or more processors are configured to execute the one or more instructions that further cause the vehicle to generate a driving performance report for the driver based on one or more attributes associated with driving the second type of vehicle.

13. The vehicle of claim 12, wherein the one or more attributes include following distance, stopping distance, or turning radius.

14. The vehicle of claim 8, wherein the one or more processors are configured to execute the one or more instructions that further cause the vehicle to modify one or more of a braking system behavior, a propulsion torque behavior, or steering angle of the vehicle to correspond to the second type of vehicle.

15. A method comprising:
determining, by a vehicle of a first type, that the vehicle is currently being operated by a driver;
receiving, by the vehicle, an input indicating selection of a second type of vehicle;
determining, by the vehicle, a plurality of parameters associated with the second type of vehicle;
configuring, by the vehicle, the vehicle using the plurality of parameters;
operating, by the vehicle, as the second type of vehicle and based the plurality of parameters;
determining, by the vehicle, one or more attributes associated with driving the second type of vehicle;
monitoring, by the vehicle, driver behavior based on the one or more attributes; and
generating, by the vehicle, a driving performance report based on the monitoring.

16. The method of claim 15, wherein the one or more attributes include following distance, stopping distance, or turn radius.

17. The method of claim 15, wherein configuring the vehicle further comprises programming one or more sensors of the vehicle based on the plurality of parameters.

18. The method of claim 17, wherein the plurality of parameters includes one or more of:
length, height, width, or gross train weight.

19. The method of claim 15, wherein configuring the vehicle further comprises modifying propulsion torque system of the vehicle using a scalar value.

20. The method of claim 19, further comprising:
determining a weighting factor based on a gross train weight of the second type of vehicle, wherein the weighting factor is between 0 and 1;
multiplying the scalar value by the weighting factor to generate a modified scalar value; and
modifying the propulsion torque system using the modified scalar value instead of the scalar value.
